(19) United States
(12) Patent Application Publication
(10) Pub. No.: US 2016/0067606 A1
(43) Pub. Date: Mar. 10, 2016

(54) Methods and Systems for Asynchronous Gaming and Progressive Simulation

(71) Applicant: Draw The Play LLC, New York, NY (US)

(72) Inventors: Marco Antonio Fernandez, Tavernier, FL (US); Fredrick Anthony Wulf, II, Center, TX (US)

(73) Assignee: DRAW THE PLAY LLC, New York, NY (US)

(21) Appl. No.: 14/701,570

(22) Filed: May 1, 2015

Related U.S. Application Data
(60) Provisional application No. 62/046,018, filed on Sep. 4, 2014.

(51) Int. Cl. A63F 13/57; A63F 13/87; G06F 3/0488; A63F 13/2145; G06F 3/16; A63F 13/795; A63F 13/23; A63F 13/828

(52) U.S. Cl. CPC A63F 13/57; A63F 13/23; A63F 13/87; A63F 13/828; A63F 13/2145; G06F 3/167; A63F 13/795; G06F 3/0488

(57) ABSTRACT

Systems, methods, and apparatuses for asynchronous gaming and progressive simulation of strategy game results derived from user input are disclosed. Using an application for a user device, such as a smart phone or tablet, users taking on offensive and defensive roles, respectively, choose respective offensive and defensive strategy definitions, and variations thereof, which may be displayed on the user device. Selected data pertaining to each strategy definition is transferred between the offensive and defensive users. The offensive and defensive strategy definitions are then integrated and simulated at a simulation engine. After simulation is complete, animations associated with and results of the simulation are provided to users along with optional commentary regarding the interaction and result of simulation.

### CROSS-REFERENCE TO RELATED APPLICATIONS

This application claims priority to and benefit of U.S. Provisional Patent Application Ser. No. 62/046,018, filed Sep. 4, 2014, entitled “Methods and Systems for Asynchronous Gaming and Progressive Simulation,” by Marco Antonio Fernandez, et al. which is incorporated by reference herein for all purposes. This application is also related to U.S. Patent Application entitled “Methods and Systems for Asynchronous Football Gaming and Progressive Simulation,” by Marco Antonio Fernandez, et al., filed concurrently herewith, and which is incorporated by reference herein for all purposes.

### STATEMENT REGARDING FEDERALLY SPONSORED RESEARCH

Not applicable.

### TECHNICAL FIELD OF THE INVENTION

The present disclosure relates generally to systems, methods, and apparatuses for asynchronous gaming and progressive simulation. More particularly, this disclosure relates to systems, methods and apparatuses for user-initiated definitions of “strategies” in a competition. Strategy definitions include information for an “interaction” of “offensive” and “defensive” strategy definitions provided asynchronously by, for example, a plurality of users. Strategy definitions from each user may be combined and used to produce a simulation of, for example, a “war game” or an athletic competition such as baseball, football, or basketball, on displays of portable devices such as smart phones and tablets.

### BACKGROUND

Typical interactive video games are used synchronously by one or more users using devices in continuous connection with a gaming system. For example, one or more users will use one or more controllers or other device to input information to be processed by the gaming system to produce a near instant result for all users of the gaming system. Interactive games may be played by users at the same location or may be played across a network such as the Internet. When playing across a network, usually information is shared between all the users's devices and the gaming system so that an output may be presented simultaneously for all users participating in a particular game. Views of information presented to different users may be the same or may be customized relative to the perspective of the users at a given gaming console. Because of the synchronous model for gaming, users must be available and interact with their respective gaming console at the time the game is being played. This requirement may make it difficult to “schedule” a match or competition between different players in significantly different time zones or who have different schedules of availability.

The disclosed embodiments of asynchronous gaming and progressive simulation address the scheduling problem outlined above and allow players to participate in successive gaming interactions at a time most appropriate for the individual user.

### SUMMARY

According to a first aspect of the invention, a computer system configured to assist in asynchronous gaming and progressive simulation is disclosed. The computer system includes a simulation engine; a network interface; and one or more processors communicatively coupled to the network interface and/or configured to execute the simulation engine. The one or more processors are further configured to receive, via the network interface, a first input regarding a first offensive strategy definition, the first input originating at a first device associated with an offensive user; provide first information via the network interface to a second device associated with a defensive user, the first information pertaining to an offensive strategy formation associated with the first offensive strategy definition; receive a second input regarding a first defensive strategy definition, the second input originating at the second device, wherein the second device need not be in active communication with the computer system when the first input is received, and the first device need not be in active communication with the computer system when the second input is received; provide at least a portion of the first input and the second input to the simulation engine for processing a simulation of a first interaction of the first offensive strategy definition and the first defensive strategy definition by, at least in part, calculating an interaction using at least a portion of the first input and at least a portion of the second input; obtain a result from the simulation engine; and provide second information to the first device, the second information comprising information to facilitate rendering, on the first device, an animation indicative of the calculated interaction.

According to a second aspect of the invention, a method for scheduling an interactive competition is disclosed. The competition to take place between a first set of users, each user of the first set of users associated with at least one of a first plurality of devices, and at least one second set of users, each user of the second set of users associated with at least one of a second plurality of devices. The interactive competition will include a number of iterations of offensive strategy and defensive strategy provided by the two sets of users. The method includes obtaining a first iteration of an offensive strategy definition provided by the first set of users; providing access to at least a portion of the first iteration of the offensive strategy definition from the second plurality of devices; presenting at least a portion of the first iteration of the offensive strategy definition as presented information to a display screen on at least one of the second plurality of devices; obtaining a first iteration of a defensive strategy definition provided by at least a portion of the at least one second set of users, the first iteration of the defensive strategy definition responsive to the presented information; providing the first iteration of the offensive strategy definition and the first iteration of the defensive strategy definition to a simulation engine; obtaining an initial condition representing a current state of the interactive competition at the simulation engine; calculating a result state using the simulation engine to apply a change to the initial condition, the change based at least in part upon the first offensive strategy and an interaction of the first offensive strategy with the first defensive strategy; and providing information to present one or more intermediate states, calculated by the simulation engine, as an animation on at least one display screen of the first or second plurality of devices, the animation indicative of the calculated interaction.

Other aspects of the embodiments described herein will become apparent from the following description and the accompanying drawings, illustrating the principles of the embodiments by way of example only.

### BRIEF DESCRIPTION OF THE DRAWINGS

The following figures form part of the present specification and are included to further demonstrate certain aspects of the present claimed subject matter, and should not be used to limit or define the present disclosure. The present claimed subject matter may be better understood by reference to one or more of these drawings in combination with the description of embodiments presented herein. Consequently, a more complete understanding of the present embodiments and further features and advantages thereof may be acquired by referring to the following description taken in conjunction with the accompanying drawings, in which like reference numerals may identify like elements, wherein:

FIG. 1 illustrates method 100 representing an iterative application game flow overview for asynchronous game play with respect to a football game according to some disclosed embodiments.

FIG. 2 illustrates method 200 representing a career play mode cycle across multiple competitions according to some disclosed embodiments.

FIG. 3 illustrates method 300 representing match scheduling and opponent selection prior to actual match play according to some disclosed embodiments.

FIG. 4 illustrates method 400 representing application game flow for an offensive user play definition and adjustment according to some disclosed embodiments.

FIG. 5 illustrates method 500 representing application game flow for a defensive user play definition and adjustment, in response to a provided offensive user play formation, and application game flow for running a simulation, according to some disclosed embodiments.

FIG. 6 illustrates a block diagram 600 of a processing system that may be used for the disclosed asynchronous application gaming systems and methods, typically incorporated into a mobile phone, tablet, or intermediate server computer, according to some disclosed embodiments.

FIG. 7 depicts multiple screenshots 700 of the disclosed asynchronous application game depicting different scenarios during match (e.g., football game) play, according to some disclosed embodiments.

FIG. 8 depicts a screenshot 800 of the initial input point for the method depicted in FIG. 3 wherein application game play is initiated by opponent selection, according to some disclosed embodiments.

FIG. 9 depicts an output screenshot 900 of the results of a coin toss with a request for user input from the winner of the coin toss, according to some disclosed embodiments.

FIG. 10 depicts a screenshot 1000 after a user chooses an offensive formation, according to some disclosed embodiments.

FIG. 11 depicts a screenshot 1100 after a user has first chosen an offensive formation, and then drawn respective paths for selected members (e.g. players) of the offensive lineup, according to some disclosed embodiments.

FIG. 12 depicts an example screenshot 1200 that might be received by a user playing defense to allow them to define their defensive formation and play for an iteration (i.e., for this turn at play), according to some disclosed embodiments.

FIG. 13 depicts a screenshot 1300 of the input screen for user inputs relating to a defensive football play definition, including defensive formations and defensive play selection (including adjustments), according to some disclosed embodiments.

FIG. 14 depicts a screenshot 1400 of the outcome (results) of a simulated football play that may be sent to the device of each user participating in the match, according to some disclosed embodiments.

FIG. 15 depicts an example screenshot 1500 of a text-based chat session relating to an associated match, according to some disclosed embodiments.

FIG. 16 depicts an example screenshot 1600 of how a user might adjust an offensive play definition using drawing gestures, according to some disclosed embodiments.

FIG. 17 depicts an example screenshot 1700 of a screen for animating simulation of a football play, according to some disclosed embodiments.

FIG. 18 depicts a screenshot 1800 of an example chat page to exchange information between users of the asynchronous application game, according to some disclosed embodiments.

FIG. 19 depicts a flow chart 1900 of an example process flow for a multi-player “war game” implementation, according to some disclosed embodiments.

### NOTATION AND NOMENCLATURE

Certain terms are used throughout the following description and claims to refer to particular system components and configurations. As one skilled in the art will appreciate, the same component may be referred to by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection, or through an indirect connection via other devices and connections.

For the sake of clarity, human players of the disclosed asynchronous game will be referred to as ‘users’ and simulated players (e.g., football, baseball, basketball players, or troop divisions, battalions, or the like) on the display field of a mobile phone or tablet will be referred to as ‘players.’ Users of the game perform the role of coaches, general managers (GMs), or military commanders and attempt to manage their “team” to victory through appropriate strategy definitions and applicable variations to pre-defined strategy definitions. In this disclosure, the term “play,” when discussing an embodiment dealing with simulation of a sport such as football, will often refer to a particular “football” (or other sport) play that is simulated as part of the interactive competition. However, the term “play” may be used as a general term to describe playing the application game itself. Context will provide the necessary distinction. When discussing an embodiment not associated with a team sport (e.g., a war game embodiment), the concept of General Manager may not exist and the “coach” would more accurately be described as a military officer (e.g., General, Colonel, etc.).

In the context of this disclosure “matches” and “competition” (e.g., a football game as a competition or a progressive war game simulation) will be used interchangeably when referring to an interactive asynchronous use of the application game to facilitate the competition between two (or more) users. The term “game” may refer to the application supporting interactive and asynchronous team sport competition between two users or may refer to the athletic game being played within the application, and context of its use will provide the proper distinction. When further distinction is necessary, the terms “application game” or “football game” and the like will be used to provide that distinction. The terms “game,” “match,” and “competition,” when used without qualification, will usually refer to the underlying implementation for the game/match/competition, that is, for example, the football game (or other game) being simulated and played asynchronously by users of the application game.

### DETAILED DESCRIPTION

The foregoing description of the figures is provided for the convenience of the reader. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness. The same or similar parts may be marked with the same or similar reference numerals.

While various embodiments are described herein, it should be appreciated that the present invention encompasses many inventive concepts that may be embodied in a wide variety of contexts. The following detailed description of exemplary embodiments, read in conjunction with the accompanying drawings, is merely illustrative and is not to be taken as limiting the scope of the invention, as it would be impossible or impractical to include all of the possible embodiments and contexts of the invention in this disclosure. Upon reading this disclosure, many alternative embodiments of the present invention will be apparent to persons of ordinary skill in the art. The scope of the invention is defined by the appended claims and equivalents thereof.

Illustrative embodiments of the invention are described below. In the interest of clarity, not all features of an actual implementation are described for every embodiment disclosed in this specification. In the development of any such actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure.

With the increasing popularity of smart mobile phones or devices, or mobile devices with built in operating systems, computer program developers have generated a multitude of applications (or “Apps”) available to the mobile device user. For example, users of Apple® platforms such as the iPhone® have access to a multitude of applications pertaining to everything from games, to reference applications (e.g., a dictionary application or language translation application), to productivity applications. Many of these are available from the Apple® App Store. Similarly, users of Android™ platforms have access to applications from the Android Market or the Amazon® Appstore for Android, and users of Microsoft® platforms such as the Windows® devices have access through the Windows® Phone Store. (Apple and iPhone are registered trademarks of Apple Inc., Cupertino, Calif. Android is a trademark of Google Inc., Mountain View, Calif. Amazon is a trademark of Amazon.com, Inc., Seattle, Wash. Microsoft and Windows are registered trademarks of Microsoft Corporation, Redmond, Wash.)

Additional devices such as the Apple® iPad® or Kindle Fire® may include modifications to the GUI and game play experience to take advantage of the large Multi-Touch screen and advanced computing capabilities of such devices compared to a mobile phone. (Apple iPad is a registered trademark of Apple Inc., Cupertino, Calif. Kindle Fire is a trademark of Amazon.com, Inc., Seattle, Wash.)

Thus, the presently disclosed embodiments may utilize iPad® capabilities (as well as capabilities of other similar devices like a smartphone, a tablet computer, a portable media player, a netbook; a smartbook, an e-Reader, etc.) to make these devices a part of a multifunctional game play experience to play a match of, e.g., an asynchronous American football game with progressive simulation of each play outcome. The simulation is “progressive” because game play involves taking the result of the previous simulation as the starting point for the next simulation. The match may be played against another user of a different device who is located in a different location. For example, users could be in proximity to each other or on different sides of the world when playing against each other in a match. It is also contemplated that a user may be able to play in single user mode against one or more automated “users” or that more than two players may have to provide input for a given iteration prior to entering a simulation function. For example, a multi-player game of combat may have multiple users on a side (e.g., allies at war) that are playing against another side of users (e.g., axis).

Initially, a user may download an “app” that provides an implementation of some or all disclosed embodiments to a user device. The app may be downloaded, for example, from the Apple® “App Store” or similar site for different devices and mobile platforms. The user may then challenge another user to commence a match (e.g., football game). Even though disclosed embodiments generally refer to an implementation for a football game, any game on any platform for any device is contemplated by this disclosure. A game may be offered through the App Store as an application that is free to download and play or for a fee. According to one method of generating revenue from the game, users may enhance their playing experience through microtransaction purchases such as buying an increase in skill level for a player. The increase in skill level may make that player a superior quarterback, blocker, or runner, for example. Additionally or alternatively, microtransaction purchases may be used to purchase a famous guest commentator to provide commentary for simulations presented via that user's application game.

In one embodiment, a game entitled “Draw the Play” is an asynchronous two-user bird's eye view American football game for the iOS and Android mobile platforms. Players are positioned on a football field by a user who acts as the coach of a team of players. The coach may select which players to put on the field, what formations begin each play, each player's position within the formation, the play they should execute for a given set of initial conditions, and how the plays are to be executed. A user's task is to strategically coach their team as it alternates through both offensive play selection and defensive play selection to victory. The successful conclusion of the game (i.e. victory) is achieved through a winning combination of team selection, formation selection (and variation/adjustment), and play execution. Play definition and alteration is achieved by the user ‘drawing out the play’ on their device. To initiate a play definition a user may optionally select from predefined plays in a playbook. A simulation of play execution involving both offensive and defensive formations and play definitions inputted by two different users (each acting as coaches) may then be animated and associated with play by play commentary. As each game/match is in progress, users may optionally communicate with each other via Facebook® Connect, text SMS messages, tweets, or other means.

Competitions (matches of an athletic game or war game simulation) may be played asynchronously across a network. Multiple users and their respective devices need not be in active communication with the server while other users are interacting with the server. Each user may provide discrete information (e.g., strategy definition information) at a time of their choosing. Then, after all required definitional information is available at a simulation engine, simulation and results may be calculated and provided to users along with an accompanying animation of the simulation. In the context of the disclosed application game with respect to athletic competitions, a first user defines strategies relating to offense actions resulting in an offensive O play definition. After O definition is complete, at least a portion of the O definition may be sent through the network (e.g., cellular, Bluetooth, Wi-Fi, or Internet) to a second user (a defensive X user) who then defines strategies relating to actions to be performed by the defense, resulting in a defensive play definition. (The first user is not necessarily limited to offensive play over the entire duration of the game, and the second user is not necessarily limited to defensive play over the entire duration of the game, but rather the users may alternate between offensive and defensive play as dictated by the rules of the particular game being played.) When defining the defensive action, the X user may see a portion of the O strategy but not further details of the O strategy definition. Once O user(s) and X user(s) have completed their strategy definitions, the intermediate and final results may be calculated using a simulation engine, and a simulation of the interaction based on the two definitions may be displayed (e.g., animated) on each user's screen (asynchronously in a preferred embodiment or even at the same time). Results generate points or gain territories (or spoils of war, etc.) for each user depending on the conventional rules of the selected competition (e.g. 6 points for a touchdown in American Football). In a war game embodiment, points may be replaced by captured territory, casualty calculations, or similar metrics for war. Application game play progresses with a second play in which the simulated outcomes of the previous play determine, according to the rules of the game, which user will be offense and which user will be defense and the game play process (formation selection, player position, play execution, and so on) is repeated. After a predetermined end point (based on any variable such as time, number of possessions, number of plays, etc.), the user with the highest number of points is declared the victor. For simplicity and clarity, further discussion of war game style embodiments will be deferred for later discussion in a separate section below. Clearly, certain aspects, such as modification to strategy definitions using drawing gestures would be applicable to at least both embodiments of athletic/sports games and embodiments of war games.

As explained above, in embodiments relating to athletic competitions, teams consist of players for different positions (e.g., quarterback, defensive safety, defensive end, running back, etc.) as is understood for American Football. Similarly, baseball, basketball or other simulated athletic competition would have appropriate players for that game's positions. Initial population and maintenance of a roster of players for a team may be accomplished in many ways (some specific examples are explained further below). Maintenance of a roster of players in American Football is typically performed by a “general manger” (GM). As explained throughout this disclosure, a user may act as a coach during a match and may also perform the role of a GM between matches (e.g., football games).

The core micro game loop for an asynchronous, turn-based component that repeats within each match in the example embodiment of a football game has at least five components: (1) Choose Offense; (2) Send move; (3) Choose Defense; (4) Send Move; and (5) Results and Analysis. Once the results and analysis are simulated, they determine the respective roles that each user will subsequently play, i.e., the results (play outcome) determine which user shall be offense and which shall be defense. To facilitate the progressive simulation aspect of the application game, each play result also defines the initial condition for play definition of the next play. Then, in the next round of play, the micro game loop is reentered. The entry cycle into the micro game loop ends when a predetermined end point is reached. This predetermined end point may be, for example, but not limited to, a set number of football possessions, as described further herein.

For the case of football, a match may be defined as a set number of football possessions for each user. During any given match, the micro game loop repeats throughout. Once a user has completed an offensive possession, a possession counter may be incremented. The end of an offensive possession may occur for different reasons. For example, an offensive possession may end with a score, a turnover (e.g., fumble or interception), or for failure to make a first down. After both game users have completed an initial turn on offense, they will each have completed a possession. In one simple embodiment, each user is given an equal number of offensive possessions, if required, for the match. Clearly, if a user is leading at the initiation of their final one of the pre-determined amount of offensive possessions, they may be declared the winner and not have to run any further plays. Alternatively, they may be required to complete their final offensive possession without allowing the defensive user to score on a turnover. The decision as to if a user must complete their final possession may be based on how close the score is at the time, because it is possible that a defensive score may or may not affect any potential outcome.

Various components may also be integrated into the game, including the user as a coach or GM of the team. The user will act as a coach, strategically coaching their team to victory in matches against other players (users) of the application game. Depending on the mode of application game play, users will attempt to win matches through formation choice, play selection, and specific alterations to pre-defined plays. The user may also act as a GM to perform acts such as roster building and team management. Various integrations to different fantasy football implementations to assist in automating general manager type decisions are discussed in a set of example integrations provided below.

Optionally, non-player characters (NPC) may also be featured such as television personalities, radio personalities, celebrities, etc., who may serve as one or more play by play announcer(s). The announcer's voice may be heard as commentary during the play simulation and/or to announce results of each play simulation. The announcer's “call” may be created using a technique for matching a set of voiceover snippets to play outcomes. Congratulatory comments to the winner may also be provided at the end of a match by the NPC. An NPC may also be the character that presents the user with unlocked formations and other unlockable content. Unlockable content refers to content in a game that is embedded in the game but not accessible to a user of the game until other certain criteria are met. These criteria may include, but not be limited to, additional purchase, attained level, entry of a special code, and so on. At a certain level (e.g., user attained experience level), the user may be able to access exclusive strategies, for example, specific formations and plays taken from actual football games. The NPC may also provide tips to users on effective strategies before, after or during a match. Each NPC and their associated features (for example, but not limited to, announcer or presenter of unlockable content or provider of specific tips) may be available as a reward for progress in application game playing or as a microtransaction purchase within the application. According to this NPC feature, the animation described herein may be further associated with audio content. In this regard, the information to facilitate rendering such animation may include information to provide on a device an audio call indicative of a play as part of the animation and concurrently with rendering the other (e.g., visual) part of the animation. As noted, however, the NPC feature may also be implemented using solely non-audio content, e.g., tips provided as textual information. The NPC feature may include both audio and non-audio content. In a war game or other embodiment, the NPC feature may still be optionally included, but the content would be modified in accordance with the nature of the game (for example, in a war game, military strategy tips could be provided by military advisors or the like).

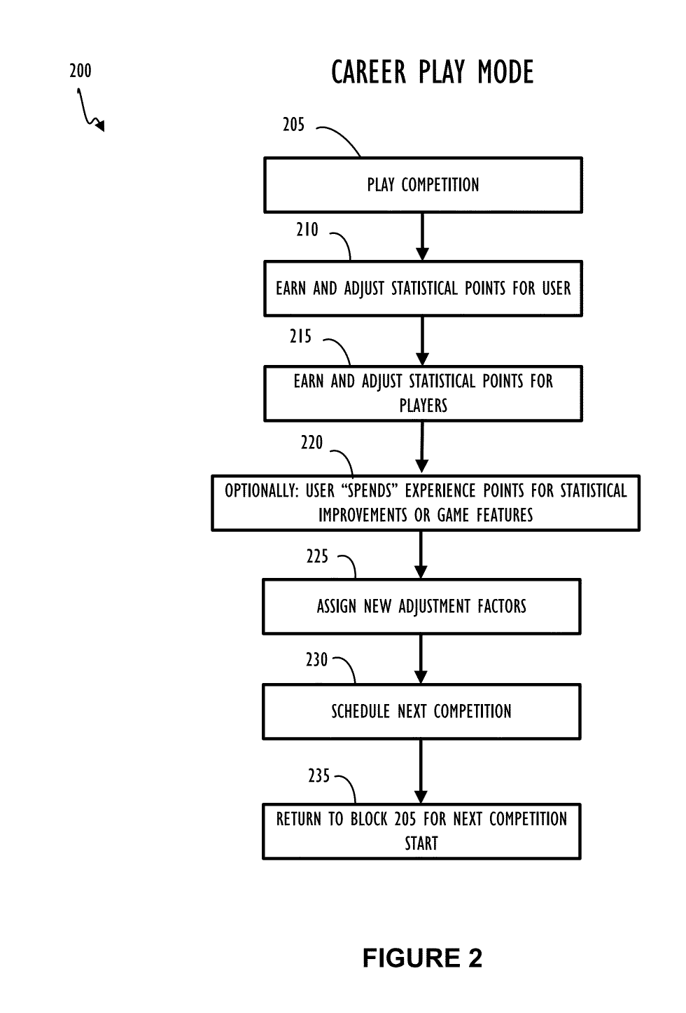

Teams may be configured to have a roster of players that will populate the field of play depending upon whether or not the player is offense or defense, and depending upon the formation selected by the user. The disclosed example embodiment representing a football game is based upon principles of the game of gridiron, using a simplified version of the rules used in National Football League (NFL) American football. However, as previously mentioned, any set of rules for a football game (or other game) may be used to implement the disclosed asynchronous play mode. A user is able to view and select team members from their team roster for different formations. Users will have the ability to build and grow their roster over time, establishing ‘ownership’ over a team that improves in terms of the individual player abilities. The user may rely on the same football players for subsequent matches which may result in one or more of the football players gaining experience over time. Gained experience may also be used to improve a particular football player's attributes and thus increase their performance in the simulation engine. The more football games a user plays, the more experienced that user's players and team become, enabling them to compete at higher and higher levels. Thus, the macro game loop consists of playing a match, earning experience through the accrual of “Stat Points” and then spending this experience for statistical improvements to a specific user's game playing activities. Thus, users are able to build and grow a team over time which encourages long term interest in game playing (see FIG. 2). Additionally, different levels of integration with different social media services may allow for league formation among a group of “friends” or “connections.” For example, members of a fantasy football league hosted on an Internet site, or even members of a social media group, may automatically be eligible as members of a league within the disclosed asynchronous application game.

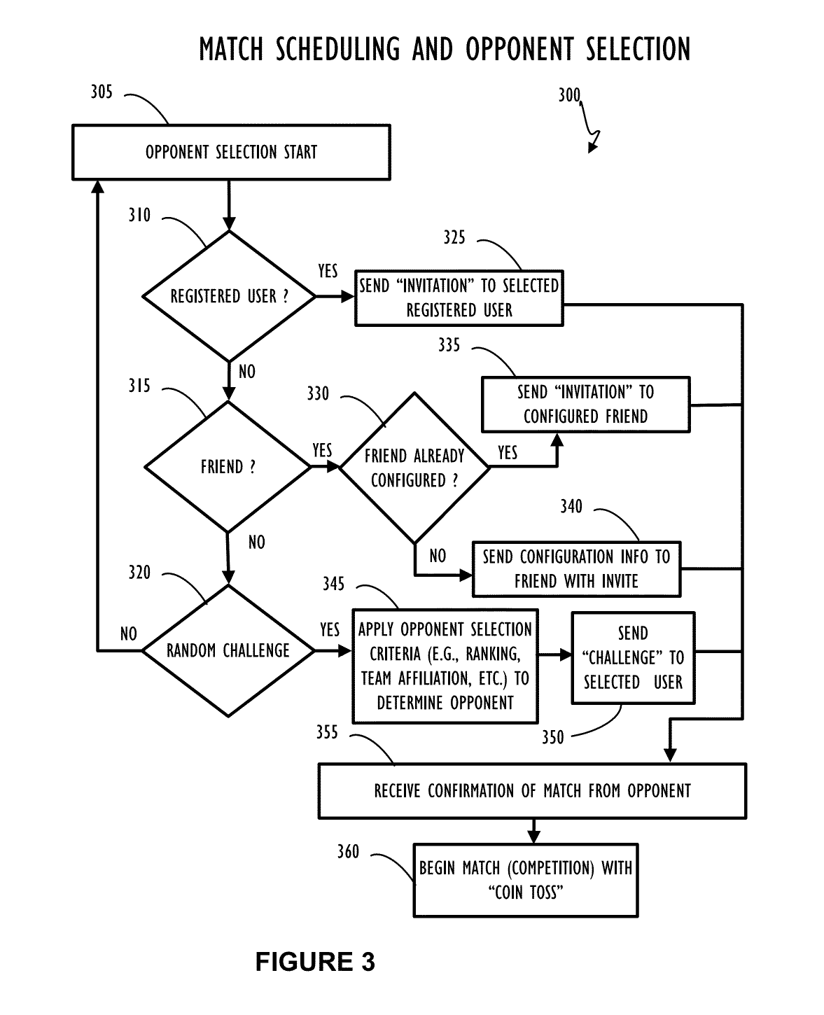

In one aspect of this disclosure, to begin a match, a user will initiate a challenge by selecting an opponent from a list of registered users/friends list or join a random challenge and be paired up against a member (e.g. another user) of the application's community (see FIG. 3). The user may select a friend that they have previously added, or send an invitation to a new friend to start a match. If the user selects to play a random match with a member of the community, he or she will be paired up, if possible, with someone having a similar ranking Thus, new users will not likely be randomly matched up against users that have been playing for a significantly longer time or have a significantly better team. Proper selection of opponents maintains competitiveness by reducing chances for one-sided matches and thus increasing long term interest by users.

In another aspect of this disclosure, a match has been initiated which then initiates a coin toss to randomly determine which user gets to choose to kick off or receive for first possession. For the coin toss, an animation may be played back to the users. In one embodiment, the coin has sides marked P1 and P2 with P1 being the user that initiated the match and P2 being the user that is joining the match (e.g., the friend or random community member). The user who is the toss winner chooses to kick-off or receive for the first possession. In some embodiments, kickoff is not simulated. For simplicity, in these embodiments, the offense may be configured, for example, to always start on their own 20 yard line after a kickoff.

Interactive competition refers to use of the application game itself. The application game, in general, comprises a feedback loop (e.g., the micro game loop described above) for a predetermined number of possessions. Each possession may follow standard rules of American football with respect to downs and distances. A change in possession may, for example, occur as the result of a turn-over, a score, a kick (e.g., punt or field goal attempt), or in any other manner recognized by football rules. In one example, each user is given ten opportunities to enter the loop as an offensive user O and a winning user may be determined at the end of those ten opportunities. Clearly, when one user is an offensive or “O” user the other user will be (for that possession) the defensive or “X” user. Alternatively, the feedback loop may be configured to execute a pre-defined number of discrete “plays” e.g., interactions of an offensive strategy definition and a defensive strategy definition. At the end of the pre-defined number of plays (regardless of number of possessions) a winner may be determined. In either case, each interaction (as calculated by the simulation engine) produces a resultant state which becomes the initial condition for the next iteration. For each cycle through the play process, after both the offensive user and the defensive user finish their play definitions, the simulation engine may be provided with enough information to execute and present the simulation to both offensive and defensive users. According to some embodiments, the user's view will not just change to the resulting state but rather will illustrate a running simulation of the play on each user's mobile phone device or other device as appropriate.

After the defensive user finishes their play definition (and prior to running simulation if desired but optional), the defensive play definition may be provided back to the offensive user's device so that the O user may also watch the simulated play. In some embodiments, if both users are available to watch the play substantially concurrently, that might provide an enhanced experience for certain important plays. After each play, the cycle may be set to begin again with the resultant state of the simulation providing the next initial condition.

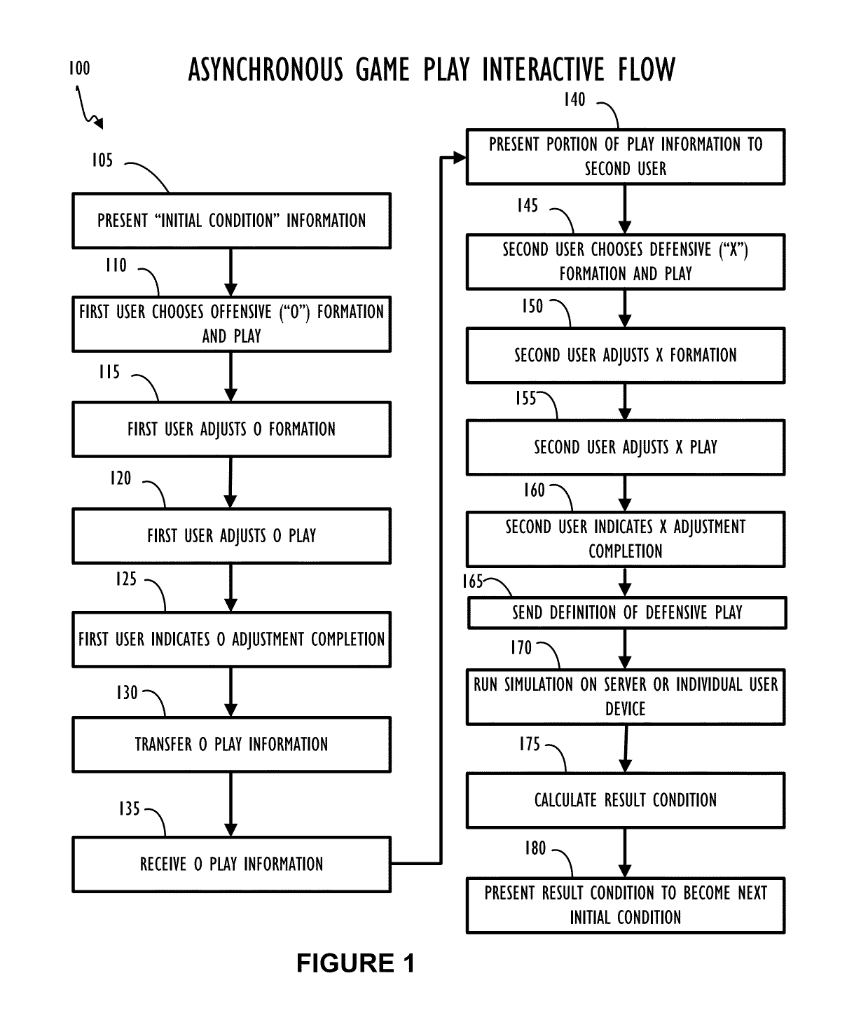

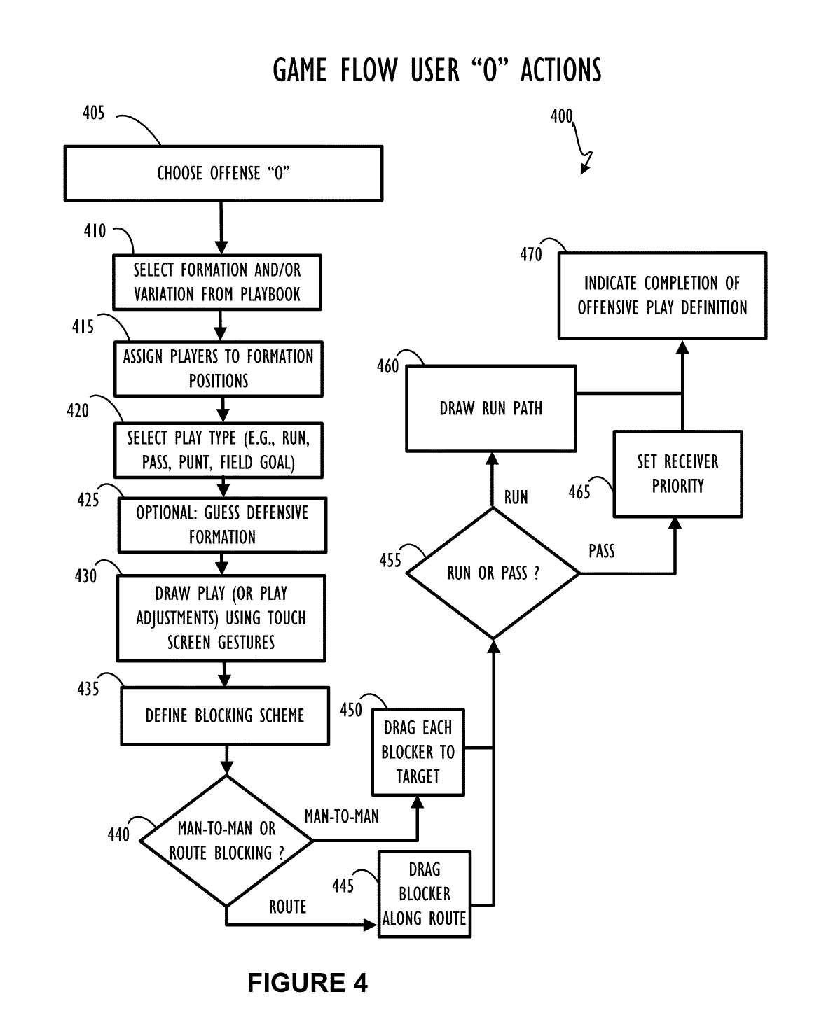

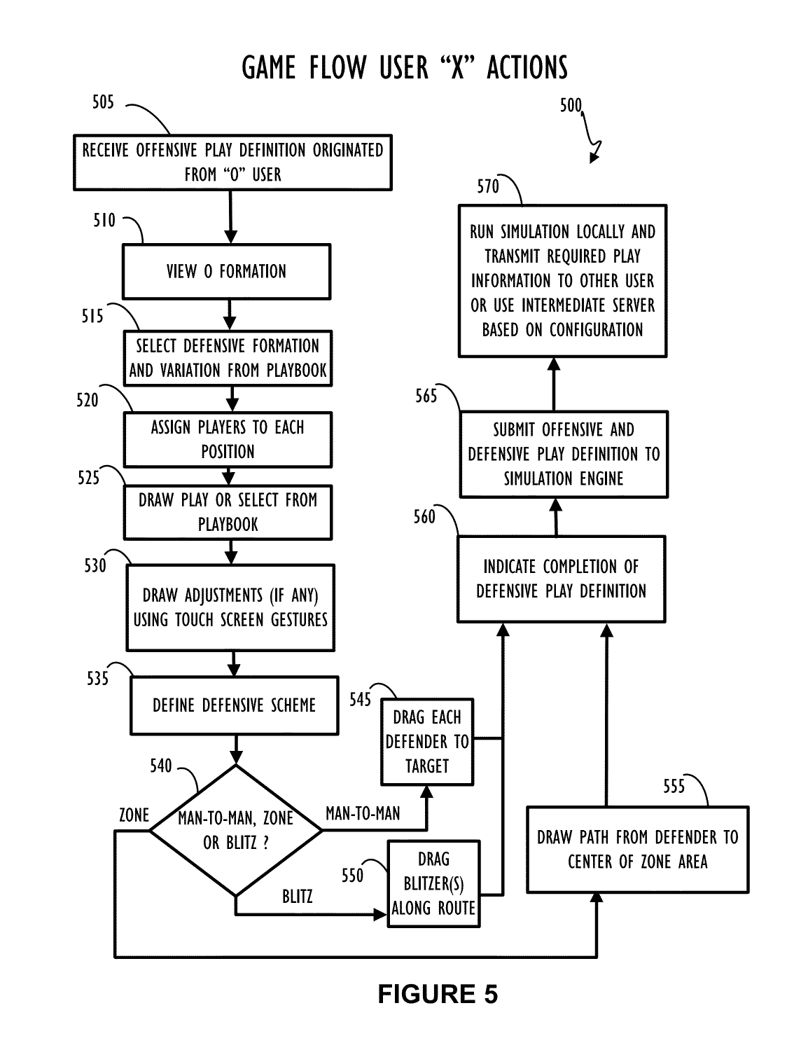

Referring to FIG. 1, method 100 illustrates an iterative “in-game” flow overview for asynchronous game play with respect to a football game, according to some disclosed embodiments. Method 100 is presented at a high level to capture overall game flow of a football game hosted by the disclosed application game and represents actions available to two users (an Offensive user “O” and a Defensive user “X”) at each football play iteration. Further actions/options available to each user, at each football play iteration, are described in more detail with reference to other figures (e.g., FIGS. 4-5). Operations prior to and after the iterative “in-game” flow of method 100 are described further with reference to other figures (e.g., FIGS. 2-3). Method 100 begins at block 105 where an initial condition is presented to the O user. According to some disclosed embodiments, the first initial condition will be first down and ten yards to go from the 20 yard line of the offensive team. At block 110 the O user chooses a formation and a play. The O user may then adjust the formation as indicated at block 115. It is optional for the O user to make adjustments or alterations at any points throughout the play definition process. In some embodiments, plays or formations may be selected from pre-set menus of available pre-set plays and schemes (e.g., from a playbook) and then optionally become user-specific via adjustment to selected default information. After adjustments to the formation are completed, flow continues to block 120 where the O user may adjust the play. After all adjustments are completed, flow continues to block 125 where the O user indicates the offensive play definition is complete. At block 130, information representative of the O play definition may be transferred to the device of the X user (or may be sent to an intermediate server). The offensive play definition is now complete.

At block 135, the X user device receives some or all of the O play information, and at block 140 the X user device presents only a portion of the O play information (e.g., the defined offensive formation) on the X user device. The X user then selects a desired defensive formation, scheme, and/or play in a similar manner to that described above for the O user (e.g., from a playbook) as indicated at block 145. Optional adjustments to override default defensive formations may be defined at block 150 as desired by the X user. At block 155, the X user may also adjust the defensive play as desired. Flow continues to block 160 in which the X user indicates that all defensive play information for this particular defensive play call has been entered. At block 165, the definition of the defensive play may be sent back to the O user device (or intermediate server). Block 170 indicates that once both offensive and defensive definitions are complete, the simulation may be run on the X and/or O user device(s) to determine and show the actions and results of the play execution. Optionally, an intermediate server could be used to execute the simulator and transmit play animation and results to each O and X user device. An intermediate server may be useful for performance reasons or other technical implementation strategies. For example, if each user device has a different architecture the animation information may have to be adapted (e.g., by the intermediate server) to be appropriate for that particular device type. If each user is using the same or similar device (e.g., devices are both compatible with a single animation definition) then the same information may be provided to both user devices (this ‘same’ information may also be referred to as a common set of information to facilitate rendering the animation). An intermediate server may also be desired if, for example, there are additional devices of non-users who have downloaded the application game and are interested in “watching” a match between two other users. Additionally, sharing of simulation results via photograph “snapshots” via third-party applications such as Facebook or Twitter are also contemplated by this disclosure. In any case, an intermediate server is not a requirement.

At block 175, a result condition of the play (e.g., results at end of simulation execution) is determined and may be provided to both the O user device and the X user device. This resultant condition becomes the next initial condition which may then be presented (block 180) to the O user device (which may have changed at the time of viewing a result of the play) and flow may begin again (for the next play) with the updated initial condition at block 105. Note that throughout asynchronous game play either user may switch between any number of devices to define their next play definition for the next iteration of the game. For example, a user may switch between and iPhone and an iPad based on their preference/location at the time in a similar manner to a user changing between different devices over time for reading/responding to emails.

Referring now to FIG. 2, method 200 represents a career play mode cycle across multiple competitions according to some disclosed embodiments. Beginning at block 205, a user completes a competition. At block 210, results of the competition may allow a user to gain statistical points for themselves based on different factors. For example, if the user defeated a user with a higher overall ranking then the successful user would gain a benefit of increased statistical stature via adjustment of their overall performance profile. Alternatively, a user may lose statistical status for a loss against a lower ranked opponent. At block 215, statistical points for players may be adjusted such that players for a particular user are either enhanced or depreciated based on overall success of the strategy for using those players implemented by the particular user. Block 220 indicates that a user may “spend” their own experience points to receive statistical improvements for their players or to unlock certain application game features. Block 225 indicates that adjustment factors (described below) are applied to the user and players associated with the user as appropriate. At block 230 a next match may be scheduled and the scheduling function, described below with reference to FIG. 3, may use the now updated user information as an input for schedule selection or suggestions. At block 235, method 200 returns to block 205 for the next match to begin.

Referring now to FIG. 3, method 300 represents a match scheduling and opponent selection process according to some embodiments. Match scheduling and opponent selection method 300 occurs prior to initiating an actual match within the application game. Method 300 begins at block 305 with a start of the opponent selection process. According to some disclosed embodiments, there are at least three different types of selection processes that a user may select. At decision block 310, a user indicates if they would like to schedule a match with another registered user. Alternatively, at decision block 315 a user may indicate that they would like to schedule a match against a “friend.” The friend may be someone that is “connected” to the user via a social media site or email. Finally, decision block 320 represents that a user may propose a random challenge to an opponent selected automatically by a game control system according to some disclosed embodiments. If no opponent selection type is selected (the NO prong of decision block 320) flow returns to block 305 to begin the opponent selection process again. If, at decision block 310, the user indicated YES to registered user opponent selection, flow continues to block 325 where an “invitation” may be sent to the selected registered user. The invitation may be sent using infrastructure supporting the asynchronous application game or may be sent via another communication mechanism (e.g., SMS text, twitter tweet, social media message, email, etc.). If a friend selection was indicated at block 315, flow continues to decision block 330 where it is determined if the selected friend is already a configured user for the appropriate competition (e.g., match). If so (the YES prong of 330), an invitation may be sent to the friend in a similar manner to what was described above for block 325. If not (the NO prong of 330), information about how to become a configured user may be sent to the selected friend (optionally with an invitation to initiate a match, once configured). If the random challenge was indicated at block 320, flow continues to block 345 where opponent selection criteria may be applied to determine an appropriate opponent for the user requesting a random pairing. Typically, users of similar skill level and experience with the application game and type of match may be paired so as to make the competition more interesting for both the requesting user and the automatically paired user. This feature allows for people that do not have any previous connection but have similar interests and/or skill level (e.g., within a skill-level threshold of each other) to participate in a competition (e.g., play a football game). After an appropriate opponent is determined, flow continues to block 350 where an invitation may be sent to “challenge” the selected user. In all cases of this particular example, once information has been sent to the selected opponent, flow continues to block 355 where confirmation is received from the selected opponent. This receipt indicates that the selection process is complete and both users agree that a competition may commence. Flow continues to block 360 where a “coin toss” for the competition may take place for the two users.

Referring now to FIG. 4, method 400 illustrates a method of application game flow for an offensive user O that may be performed to select defaults and provide desired alterations to complete an offensive play definition. Beginning at block 405, the O user begins their play definition. At block 410, a formation (or a pre-set variation to an offensive formation) is selected from a playbook as a starting point. The O user may then assign players to different positions in the formation or may select a default assignment as indicated at block 415. At block 420, a play type may be selected. As in real football, the play type selection will be based on the O user's strategy preference while taking into consideration the initial condition of the play (e.g., down, distance, field position, momentum, etc.). At block 425, the O user may make an optional guess of what the defensive formation will be to assist in their play selection and adjustment. Block 430 indicates that adjustments or play definition attributes may be defined using touch screen gestures like dragging an icon representing a player along a desired path. At block 435 of FIG. 4, a blocking scheme may be defined (e.g., selected from a menu). If man-to-man blocking is desired as indicated at decision block 440, flow continues to block 450 where the O user may (by means of gestures on the touch screen) drag each blocker to that blocker's designated assignment. Alternatively, if route blocking is selected at decision block 440, flow continues to block 445 and each blocker may be dragged (again using gestures on the touch screen) along that blocker's designated blocking path. After blocking assignments are complete, the O user may indicate if it is a run or pass at decision block 455. Alternatively, this may be determined automatically by the application game based on the O user's input at block 420. If run, flow continues to block 460 where the O user may draw the path for the runner to follow. If pass, flow continues to block 465 where the O user may set the receiver priority to indicate a preference of which receivers should be targeted by the quarterback and in what order. From block 460 or 465, flow continues to block 470 where the O user indicates that the offensive play definition has been completed.

Referring now to FIG. 5, method 500 illustrates a method of application game flow for a defensive user X that may be performed to select defaults and provide desired alterations/adjustments to complete a defensive play definition. FIG. 5 also includes application game flow for running a simulation. Beginning at block 505, the X user receives the completed offensive play definition as a result of method 400 of FIG. 4. At block 510, the X user may see the formation of the offense as defined by the O user for this particular play but may not see further information such as play type or blocking information. Based on the X user's interpretation of the formation, the X user selects a defensive formation (or variation) from a playbook as indicated at block 515. At block 520, the X user assigns their desired players to positions in the defensive formation or indicates that a default assignment is appropriate. At block 525, the X user draws an initial defensive play or selects an initial defensive play available from a series of standard defensive plays in a playbook. Flow continues to block 530, where the X user may draw adjustments (if any) using touch screen gestures. At block 535, the X user defines a blocking scheme. Decision block 540 illustrates three example defensive schemes that may be available for selection, according to this example. Of course, in different situations more or fewer options of defensive schemes may be available for selection. If a zone defensive scheme is selected at decision block 540, flow continues to block 555 where the X user may draw a path from an applicable defender to the center of the zone area that this defensive player will be assigned to cover. If a blitz scheme is selected at decision block 540, flow continues to block 550 where the X user may drag blitzer(s) along a route indicating how each defensive player (e.g., blitzer) should blitz the offensive formation. If a man-to-man defensive scheme is selected at decision block 540, flow continues to block 545 where the X user may drag defensive players to the opponent player on offense that the defensive player is assigned to cover. After block 545, 550 or 555, flow then continues to block 560 where an indication may be provided by the X user that the defensive play information is complete. At this point, there is a complete play definition for both offense and defense from a common set of initial conditions that may be submitted to a simulation engine as indicated at block 565. Flow continues to block 570 where a simulation may be initiated in a variety of ways. In some embodiments, simulations may be performed on each end user's device once complete information has been conveyed to the respective device. Simulations are typically performed/displayed on the O and X users' devices at different times which may be initiated by each individual user checking game status. In some embodiments, the user may receive an indication that a play definition has been completed by the other user much in the same manner as receiving a text message (optionally it may be a text message). Alternatively to running simulations on user devices, an intermediate server may be used to run the simulation or portion thereof. After completion of this simulation presentation, play flow may continue to a next play as indicated above in FIG. 1. It is important to note that the simulation engine will receive both offensive and defensive play definitions to perform each football play simulation. The simulation engine also has access to attribute information about players (e.g., player size, speed, skill, experience, and so on). The simulation engine utilizes this attribute information as part of its result determination to mimic real life football. For example, a small player of low skill/experience defined to block a large experienced player will likely be ineffective in that blocking assignment. Thus, simulation results may be calculated accordingly to indicate failure of the blocker. In another example, a slow player assigned to cover a fast receiver may fail in their coverage assignment.

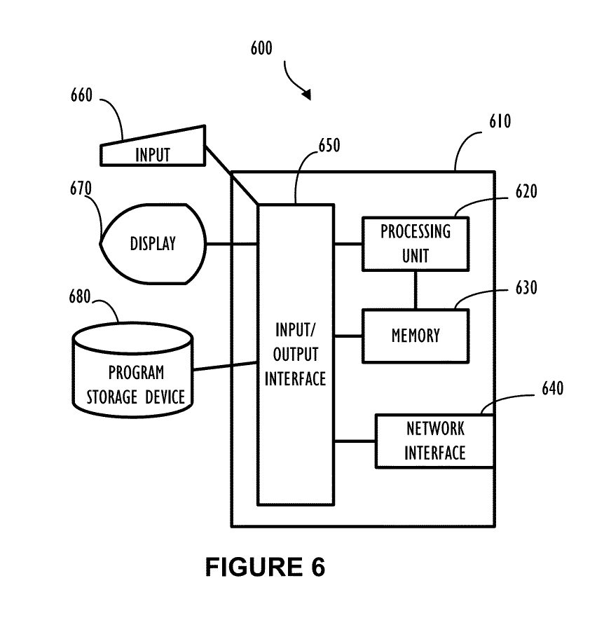

Referring now to FIG. 6, possible internals and peripheral components of an example device 600, which may be used to practice the disclosed functional capabilities of an asynchronous application gaming method such as shown in FIGS. 1-5, are shown. Example device 600 comprises a programmable control device 610 which may be optionally connected to input device 660 (e.g., keyboard, mouse, touch screen, and so on), display 670 and/or program storage device 680. Also, included with programmable control device 610 is a network interface 640 for communication via a network (e.g., wired, wireless, cellular, and so on) with other computers and infrastructure devices (not shown). Note network interface 640 may be included within programmable control device 610 or be external to programmable control device 610. In either case, programmable control device 610 may be communicatively coupled to network interface 640. Also, note Program Storage Device (PSD) 680 represents any form of non-volatile storage including, but not limited to, all forms of optical and magnetic storage elements including solid-state storage.

Program control device 610 may be included in a device 600 and be programmed to perform methods in accordance with this disclosure. Program control device 610 comprises a processor unit (PU) 620, input-output (I/O) interface 650 and memory 630. Processing unit (PU) 620 may include any programmable controller device including, for example, the Intel Core®, Pentium® and Celeron® processor families from Intel and the Cortex® and ARM® processor families from ARM® (INTEL® CORE®, PENTIUM® and CELERON® are registered trademarks of the Intel Corporation. CORTEX® and ARM® are registered trademarks of the ARM Holdings.) Memory 630 may include one or more memory modules and comprise random access memory (RAM), read only memory (ROM), programmable read only memory (PROM), programmable read-write memory, and solid state memory. One of ordinary skill in the art will also recognize that PU 620 may also include some internal memory including, for example, cache memory.

Various changes in the materials, components, circuit elements, as well as in the details of the illustrated systems, devices and below described operational methods are possible without departing from the scope of the claims herein. For instance, acts in accordance with disclosed functional capabilities may be performed by a programmable control device executing instructions organized into one or more modules (comprised of computer program code or instructions). A programmable control device may be a single computer processor (e.g., processing unit 620), a plurality of computer processors coupled by a communications link or one or more special purpose processors (e.g., a digital signal processor or DSP). Such a programmable control device may be one element in a larger data processing system such as a general purpose computer system. Storage media, as embodied in storage devices such as program storage device 680 and memory internal to program control device 610 are suitable for tangibly embodying computer program instructions. Storage media may include, but not be limited to: magnetic disks (fixed, floppy, and removable) and tape; optical media such as CD-ROMs and digital video disks (DVDs); and semiconductor memory devices such as Electrically Programmable Read-Only Memory (EPROM), Electrically Erasable Programmable Read-Only Memory (EEPROM), Programmable Gate Arrays and flash devices. These types of storage media are also sometimes referred to as a computer readable medium or a program storage device.

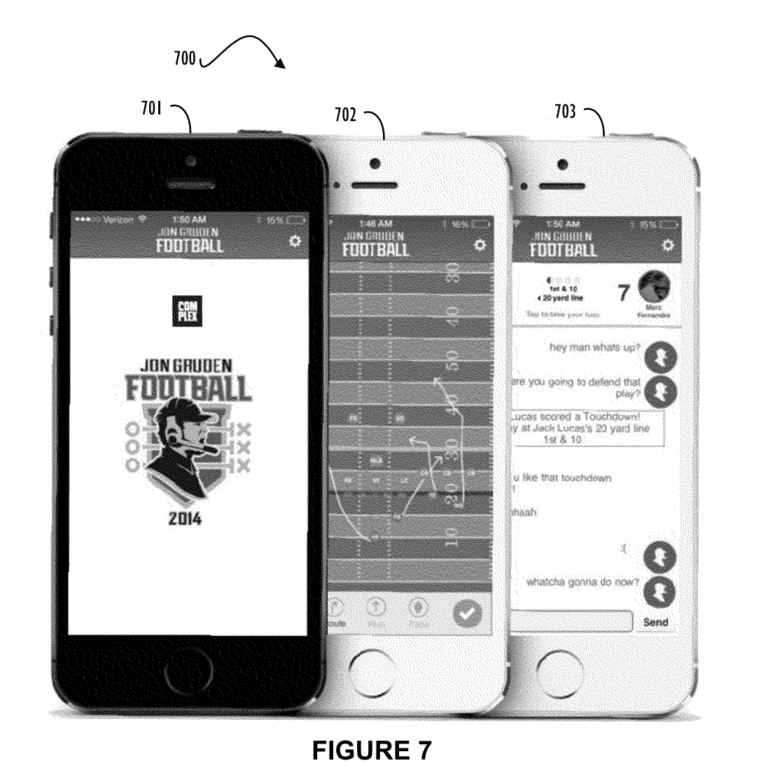

Referring now to FIG. 7, multiple screenshots 700 of application game play on an example hand held mobile smart phone device depict various points in application game play of a match of an asynchronous football game according to some disclosed embodiments. Screenshot 701 illustrates an initial exemplary introductory screen displayed to a user prior to the commencement of game play. Screenshot 702 illustrates an exemplary screen wherein an O user has drawn in an offensive play. Screenshot 703 illustrates an exemplary screen wherein the O and X users exchange commentary regarding ongoing game play using the “chat” feature. Also depicted is a summary result of a simulation of game play, the results of which are the subject of further chat commentary by the X and O users. These screenshots will be described in greater detail below with reference to FIGS. 11, 13 and 15.

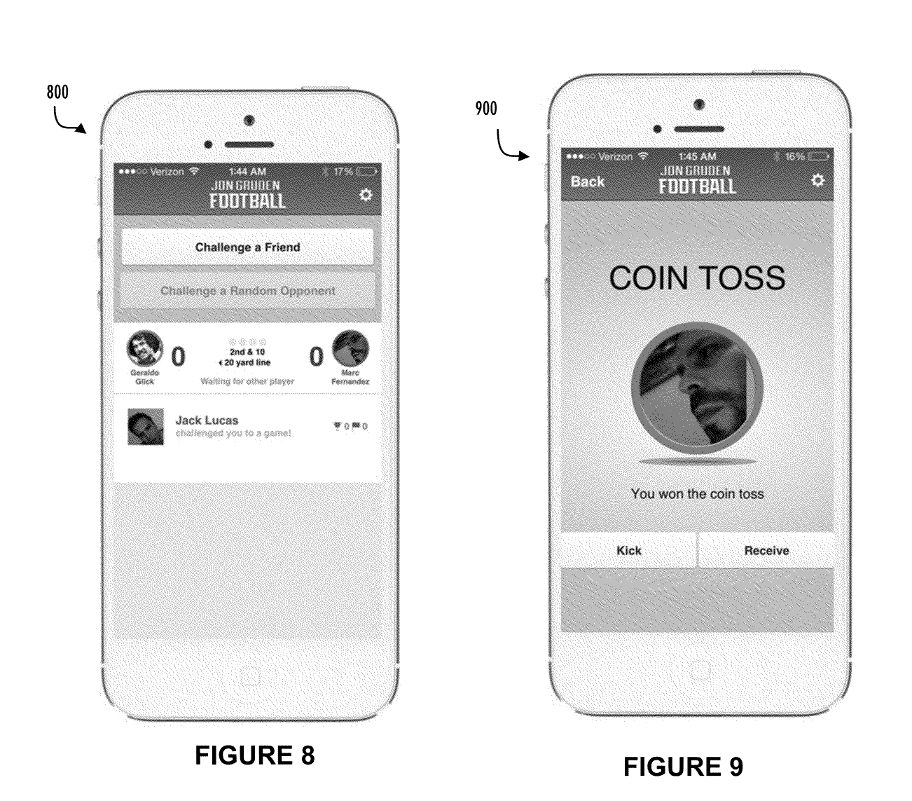

Referring now to FIG. 8, a screenshot 800 of the initial input point for the method 300 depicted in FIG. 3 wherein application game play is initiated by an opponent selection starting at block 305 is depicted. Screenshot 800 represents an entry point into the match scheduling and selection process of method 300 of FIG. 3 for each of “Challenge a friend” (block 315) and “Challenge a Random Opponent” (block 320). The “Challenge a Random Opponent” option may be used to associate the user with a random opponent selected from users that have already downloaded and installed the application.

Referring now to FIG. 9, an output screenshot 900 of the result of a coin toss is depicted. Once a challenge is accepted, and begin match (competition) block 360 of FIG. 3 is entered, a coin toss sequence may be automatically initiated (not shown). As depicted in screenshot 900, the user who is the winner of the coin toss sequence is then prompted to choose between the option of “Kick” or “Receive”. If the user who is the winner of the coin toss chooses “Receive”, application game play for the user enters block 110 of FIG. 1, where this first user chooses an offensive “O” formation. Alternatively, if the winner of the coin toss chooses “Kick”, then application game play enters block 110 of FIG. 1 for the other user (the loser of the coin toss) to start as an offensive O user. The winner, who has chosen to start as a defensive “X” user, waits till flow enters block 145 of FIG. 1.

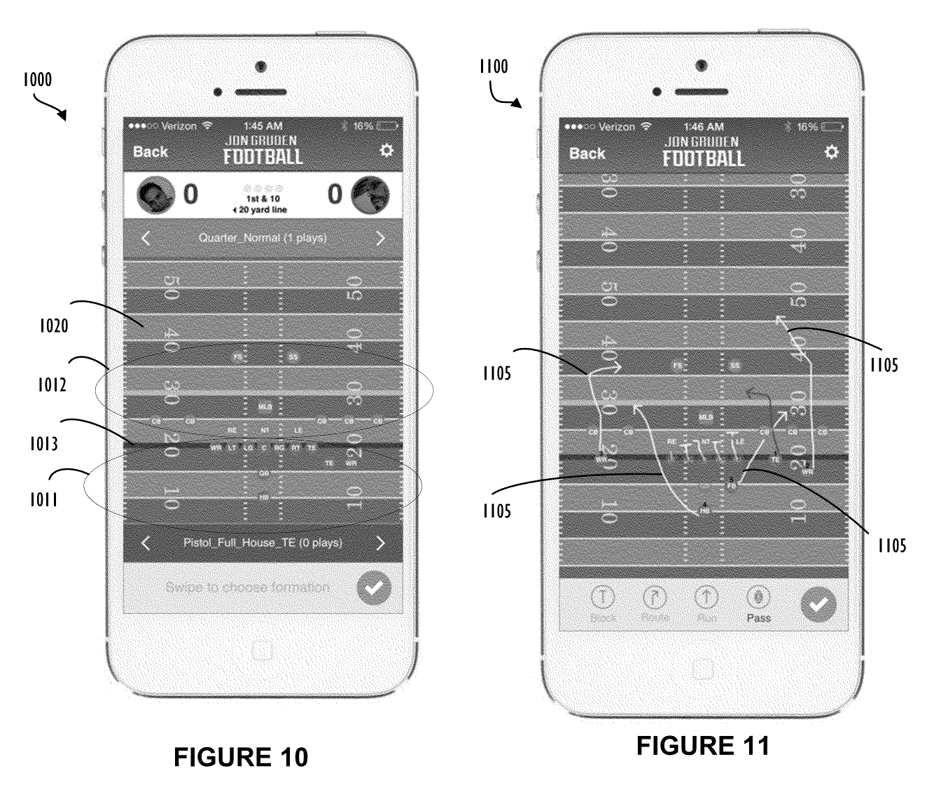

If the first user wins the coin toss and chooses to “Receive,” the first user is prompted to define and adjust an O formation (see blocks 110 and 115 of FIG. 1). This O user on offense picks from a selection of formations that may be pre-populated. For example, Table 1 provides a summary of various possible formations but is not meant to limit the scope of this disclosure in any way. FIG. 10 depicts screenshot 1000 showing the playing field 1020 after the “Pistol” formation is chosen as the offensive formation 1011. FIG. 10 also shows the defensive team in a defensive formation 1012, opposite the line of scrimmage 1013 from the offensive formation 1011. The players shown in FIG. 10 are identified by abbreviations: QB (quarterback), HB (halfback) etc. In addition to the available formations, an O user may instead choose to modify the chosen formation further, termed a “formation variation” or “variation”. A variation may, for example, move the quarterback further from the line of scrimmage than what is standard for a typical “Pistol” formation.

TABLE 1

| | Offense | Offense | | |
|---|---|---|---|---|
| Offense | Plays | Plays | Defense | Defense |
| Formations | (Running) | (Passing) | Formations | Schemes |
| Pro set | Plunge/ | Fly route | 4-3 | Man |
| | Dive | | | to man |
| Shotgun | Sweep | Slant route | 6-1 | Zone |
| formation | | | | |
| Wishbone | Reverse | Out route | 3-4 | Blitz |
| formation | | | | |
| I formation | Off Tackle | Screen pass | 5-2 | Rush |
| Single wing | Student | Button hook | 5-3 | Stunts |
| formation | Body Right | | | |
| Goal Line | Draw | Corner Route | 4-4 | |
| formation | | | | |
| Single set | Counter Trey | Hail Mary | 3-3-5 | |
| back | | | | |
| Wildcat | Quarterback | Fly route | 6-2 | |
| formation | sneak | | | |
| Pistol | QB sweep | Pass routes- Go | 46 defense | |
| formation | | | | |
| Victory (V) | Bootleg | Pass route - | Nickel | |
| formation | | Post | | |
| T formation | Option | Pass route -Flag | Dime | |
| Double | Counter | Pass route- | Quarter or | |
| Wing | | In/Drag | Prevent | |
| Short punt | Power | Pass route- | “Eight in the | |
| formation | | Hook/Hitch | box” | |
| Flexbone | Zone | Pass route- Flat | 38 defense | |
| | | | (split | |
| | | | middle) | |
| Wing T | Trap run | Pass route- | Half-dollar | |
| | | Option routes | | |
| Empty | Up the | Play-Action | | |
| backfield | middle | | | |
| Goal line | Toss | Trick/gadget | | |
| formation | | plays | | |
| Veer | Draw | | | |
| formation | | | | |
| Kneel | End around | | | |
| Emory and | | | | |
| Henry | | | | |

Once the formation is picked, the O user may draw their own custom pass or run play modifications as depicted in FIG. 11, screenshot 1100. As noted in FIG. 4, options for different offensive players include, but are not limited to, “Block”, “Route”, “Run” and “Pass”. User's intent about a chosen action is transferred to the device via intuitive controls (using a finger and sweeping motion, or a stylus, or other means) that let the O user draw their own offensive blocking patterns, receiver routes, running schemes, and passing priorities. Drawing gestures are represented in screenshot 1100 by arrowed lines 1105 showing a portion of the user's modifications to positions of players. Once the O user finishes drawing out their custom pass or run play, a corresponding play definition may be sent to the opponent X user representing the defensive side. The average time frame for an O user undertaking an offense input may be less than 20 seconds which permits rapid information transfer and upload of chosen data to another X user (or opponent).

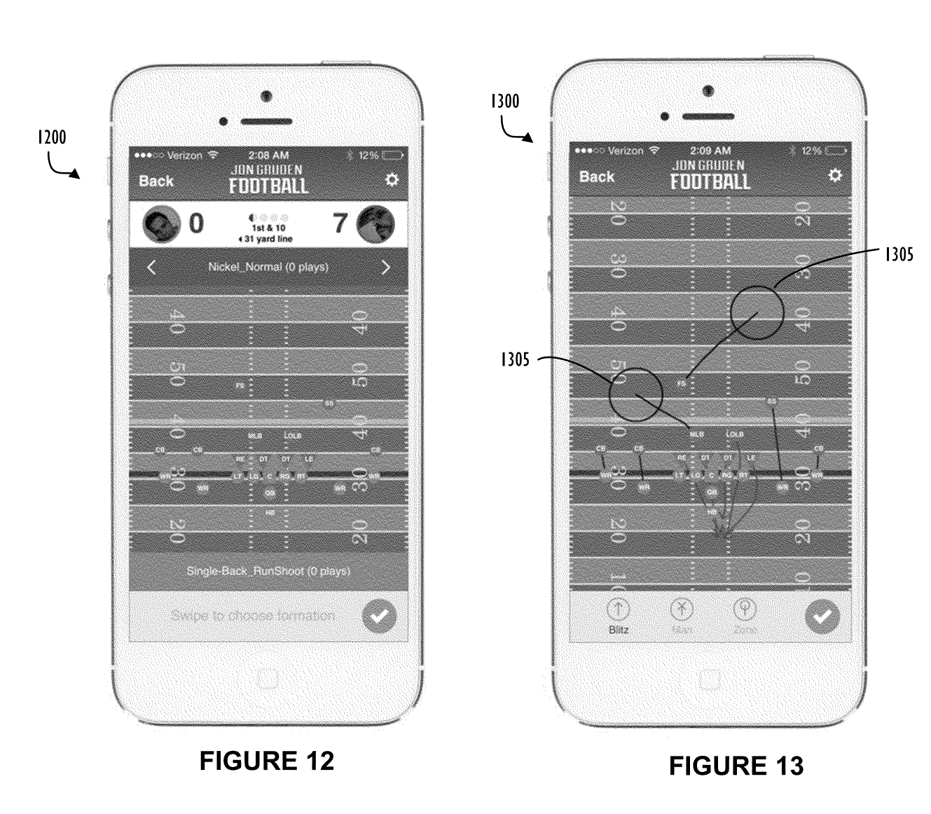

In an alternative aspect of the present disclosure, the offense O user may choose from a series of standard pass or run plays. Table 1 provides a summary of various running and passing plays but shall not be construed to limit the scope of the disclosure in any way. Other offensive formations and plays are contemplated by the present invention. It is important to note that only the formation and NOT the associated (custom or standard) pass or run play is displayed to the opponent X user that is on defense. As shown in screenshot 1200 of FIG. 12, for example, the only offensive data shown to the X user on defense is the offensive formation 1211, referred to in FIG. 12 as the “Single Back Run Shoot.” These figures are not representative of the progressive flow of the same play but are instead only illustrative of different plays that may occur during a game. Thus, the figures are exemplary, illustrations of features of asynchronous game play rather than a particular underlying football game itself.

Once the X user acting as the defensive coach in the football game, receives the offensive O user's formation data, the defensive X user chooses the formation they feel best suited for a defense to the provided offensive formation. As depicted in FIG. 12, this may be, for example the “Nickel Normal” defense. It is envisioned that other defensive formations such as those summarized in Table 1 may be incorporated into the application game. The X user then chooses a defensive scheme such as a blitz, man, or zone and may adjust or further define for each defensive player position. As depicted in screenshot 1300 of FIG. 13 these definitions may be provided by using drawing gestures in a similar manner as was described above with respect to FIG. 11 and the O user. Other defensive formations, plays and schemes are contemplated by the present disclosure. Circles 1305 each represent a defensive zone area associated with a particular defensive player as defined, for example, by a drawing gesture of the defensive X user. In an alternative aspect of the present disclosure, the defensive X user may design a series of custom defensive formations and schemes.

It is also contemplated that the game includes an expansive “playbook” providing selectable standard defensive and offensive formations, plays and schemes. One such example of definitions of plays, formations, and schemes, entitled “PLAYBOOK: Offensive Football—A Great Way to Start: Split Backs & I Formation,” is included in the appendix to the above mentioned provisional application filing and is incorporated by reference herein in its entirety.

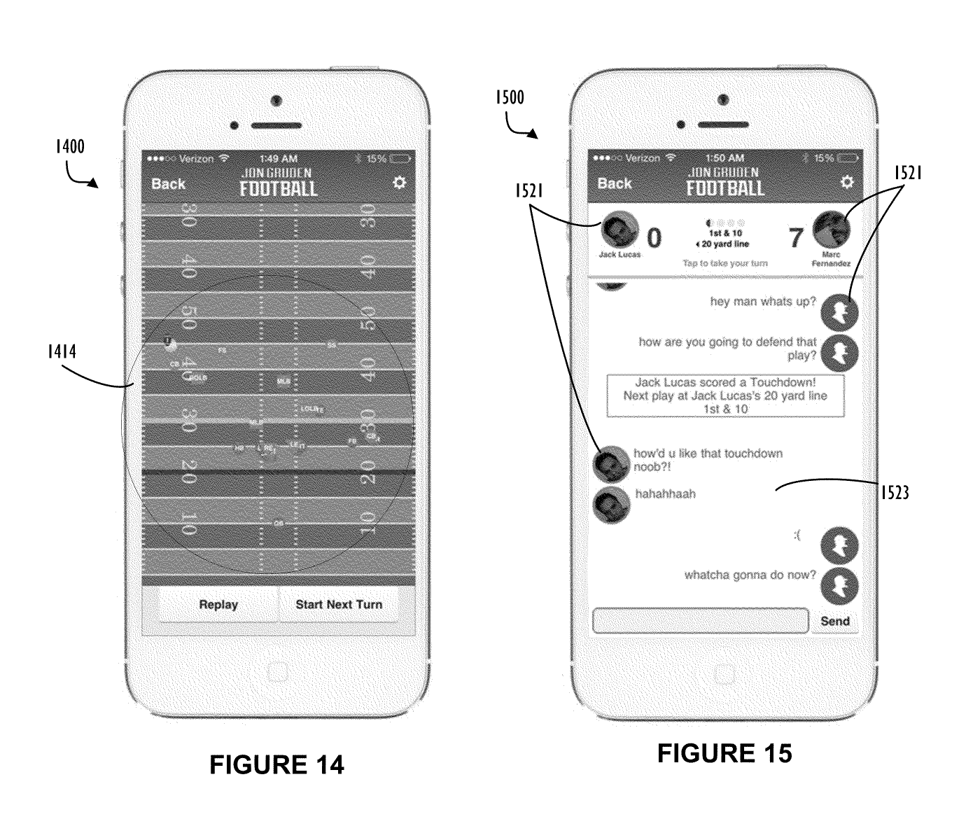

Once the defensive X user finishes a complete defensive play definition (e.g., by drawing out the defensive scheme/adjustments), defensive play definition data may be transferred to a device which aggregates the offense and defense data to produce a complete play definition. The complete play definition may then be provided to a simulation engine to determine an outcome or result. As shown in screenshot 1400 of FIG. 14, information depicting the outcome of the simulated play may be sent to the device of each user to display a visualization of the outcome 1414 defined as a result condition in block 175 of FIG. 1 for the defined offense and defense actions. Optionally, a play by play commentary may be provided that is customized to each simulation.

As depicted in FIG. 14, depending on the outcome, each user may then upload input (start their next turn) as either a defensive or offensive user. The application game then returns to block 105 of method 100 described in FIG. 1 again. For example, if the outcome results in an interception of the ball, the user that began the previous play as offense is now defense (i.e., X user) and has lost possession of the ball. As explained in FIG. 1, play definition begins with an offensive play definition by the user in possession of the ball.

The entire process of application game play may be repeated until the set number of possessions for each user is reached. Football game length is not determined by time because the game is asynchronous and based on a number of possessions. It is also to be understood that other methods for limiting play time may be used such as number of football plays.

Optionally, each user may customize the player attributes for each offensive and/or defensive player which, in turn, may affect the simulation and therefore each result condition 175. As yet another feature of this disclosure, throughout game play, users, represented by their icons or avatars 1521, 1522, are encouraged to converse 1523 with each other through the use of a built-in chat system with push notifications which is free of SMS charges, as depicted in screenshot 1500 of FIG. 15. In yet another aspect of this disclosure, a user may prefer other communications means such as e-mail or the features of another application such as Facebook® Connect (not shown). Facebook is a registered trademark of Facebook Inc., Menlo Park, Calif.

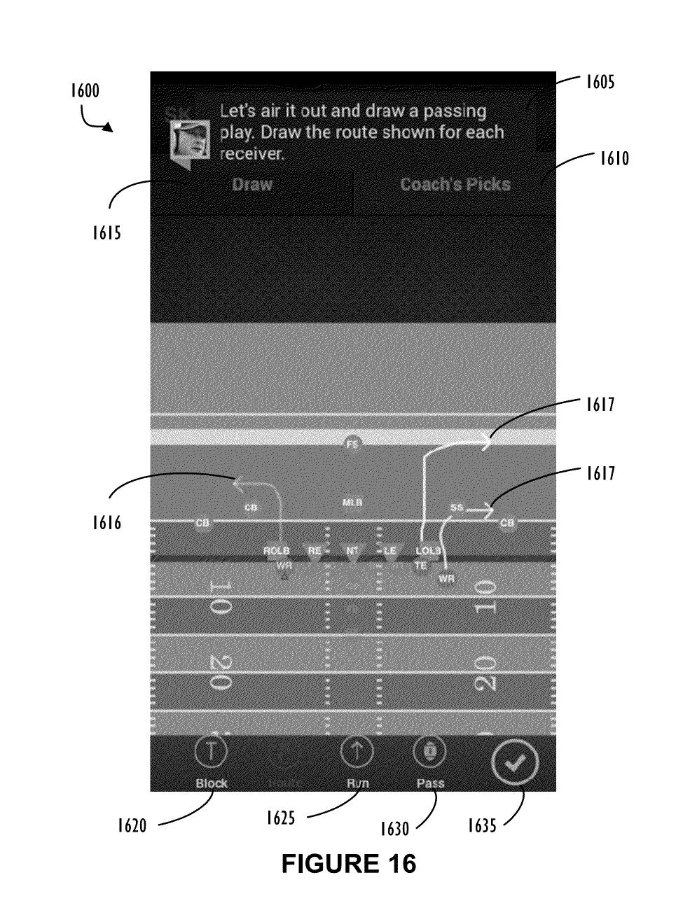

FIG. 16 depicts screenshot 1600 showing a more detailed view of a screen that may be used by the offensive O user to select and adjust a play to provide a comprehensive offensive play definition as described above. Block 1605 illustrates an area that may be used to receive additional advice or help for the offensive user. In that regard, block 1610 represents a softkey that may be used to get a suggested play as in a “Coach's Pick.” Block 1615 represents a softkey that may be used to allow a user to enter “draw” mode where screen gestures may be used to alter a play definition on a player-by-player basis. For example, an O user may draw the path for the offensive player to follow during the play by simply dragging their finger from that player along a desired path (e.g., route) as illustrated with arrowed lines 1617. Arrowed line 1616 represents a default path that has not yet been altered by the offensive user. Note that altering of paths (e.g., routes) is optional and may be done for none, some, or all players that are expected to run a route during the play being defined. Area 1620 represents a softkey to define blocking formations. Area 1625 represents a softkey to define run formations and running routes. Area 1630 represents a softkey to define pass. Area 1635 represents a softkey for the offensive user to acknowledge that the offensive play definition is complete.

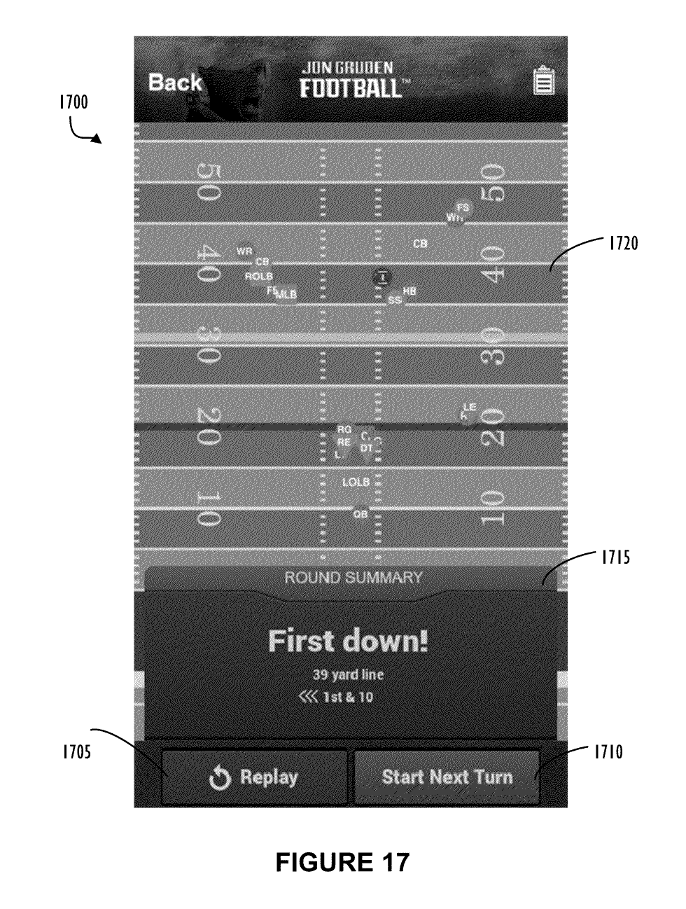

FIG. 17 depicts screenshot 1700 showing a screen at the end of an animation of simulation, according to some disclosed embodiments. Area 1720 represents an animation area/the simulated playing field. Inputted offensive and defensive play definitions may be processed by a simulation engine to produce a result, and the animation area 1720 would show intermediate progress of players during the simulation. Area 1715 represents a summary area displaying results of the current simulation and starting (e.g., initial) conditions of the next play. Area 1705 represents a softkey to allow a user to replay the most recent animation (or simulation results). Area 1710 represents a softkey to allow a user to proceed to the next play (e.g., start next turn). Due to the asynchronous nature of the disclosed embodiments, it is possible for an offensive O user to have completed their next play definition well before the defensive X user has even viewed the simulation on their device. Alternatively, play may be held until both users have seen a previous play's results.

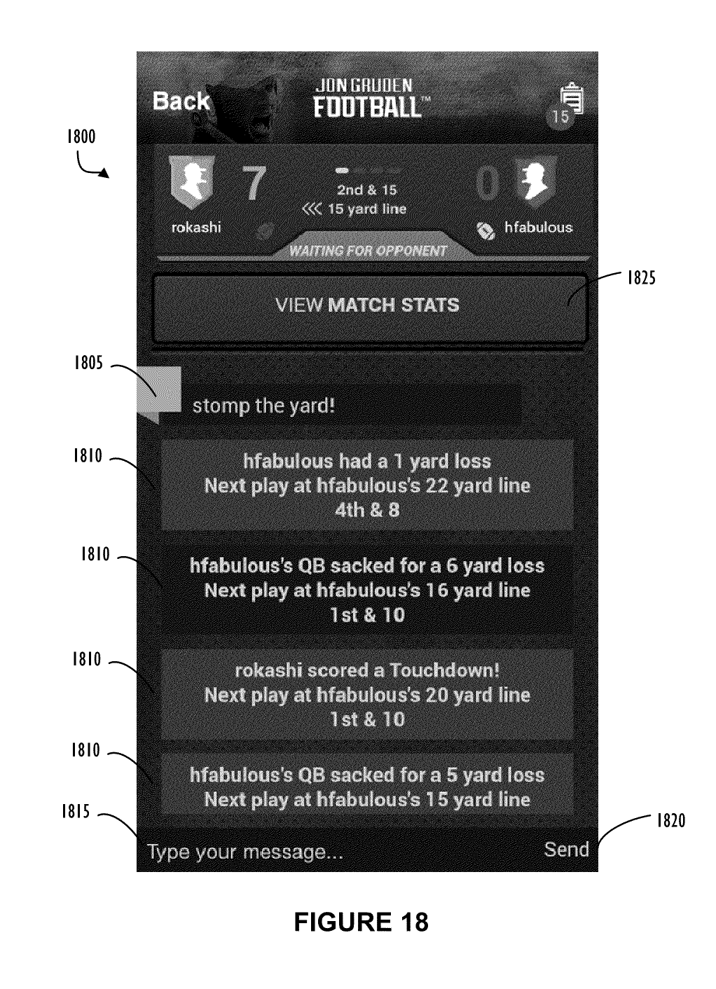

Referring to FIG. 18, screen shot 1800 is another representation of a chat screen that may be used by users to communicate with each other during a game. Block 1805 illustrates a chat message by one of the users. Blocks 1810 represent play information and statistics about sequential plays outputted and displayed by the application game. Area 1815 represents a softkey to initiate an interface (not shown) for a user to type a message to be placed in-line with other comments about the game in progress. Area 1820 represents a softkey to send a typed message. Area 1825 represents a softkey to bring up an additional screen to show statistics for the football game in progress.

Roster Population and Maintenance

Having the understanding provided above with respect to disclosed embodiments of asynchronous football gaming, several examples of team roster maintenance and possible integration with other gaming sites (e.g., fantasy football sites) are now provided. In a first example, a team may be defined completely from scratch by a user. The user may be given the ability to assign names, numbers, and positions to fictitious (e.g., user defined) players. A user in this example may be given a “skill cap” that acts much like a salary cap or budget to assign skill levels to different players. In that manner a user may have to choose which positions on his team will have a higher skill component as the user will not be able to assign high levels of skill to all positions. In this example, a user may be able to define an excellent quarterback at the expense of some other position on the field. By default, all positions may be given a base set of skills and a user may take skill from one position (e.g., fullback) and apply that as additional skill for another position (e.g., quarterback). Thus, a user may act as a GM to build a team with appropriate skill components based on the types of strategy they may use when acting as the coach of that team. Further, upgrades to the skill cap may be purchased (e.g., through microtransactions within a game) as a form of luxury tax for not adhering to the previously defined skill cap.

In a second example, rosters may be imported from a fantasy football league. In this example, skill levels for players within the asynchronous football game may be adjusted based on the corresponding real world player's effectiveness in a real game. For example a rookie player may be considered an emerging star and that player's skill level within the asynchronous football game may be substantially increased for the following week. In this embodiment, it may be desirable to keep skill levels consistent throughout a given match (e.g., asynchronous game) because it is possible that a match may continue across a week boundary (matches have no pre-determined time limit for play).

In a third example, rosters may again be imported from a fantasy football league but for season long play. In this example, team rosters are not completely changed each week but skill levels may be adjusted based on corresponding player performance throughout the real life season. In this example, team skill levels may be initially assigned based on performance in a prior season and then adjusted as necessary throughout a simulated season of the disclosed application game play.

Users may choose to challenge each other based on their team's skill level as of a given week in a real life season. In that case, skill levels may be set based on corresponding player performance through that point in the real season regardless of when the simulated game is actually taking place. In some embodiments a first user may populate his/her team with the Dolphins' undefeated roster of 1972 and the other user may choose to populate his/her team with the undefeated regular season 2007 Patriots' roster. These two historical teams could then face off against each other in the disclosed simulated asynchronous gaming application. In another example, two users may set up a “rematch” of a previous played real season game with each user acting as the new coach of the selected teams (permitting integration of “armchair quarterbacking”).

As explained above, matches have no pre-determined time limit for play and may be discontinued at any time by one or both users. If only one user wishes to withdraw the other user may be declared the winner for that match (e.g., football game). Alternatively, either user may initiate an “invite” to end the match based on mutual consent, and, if accepted, that match may result in a tie. Thus, comprehensive statistics with regard to user performance across matches may be maintained. Obviously, in an elimination playoff system a tie would not be an acceptable outcome because one of the two teams must advance to a next round.

War Game Style Embodiments

Having the above understanding of asynchronous play in the context of an athletic competition we now turn to a discussion of a war game style embodiment for asynchronous gaming according to aspects of this disclosure. In a war game style embodiment, it is possible to have many more than two players. For example, two players may work together to define an assault strategy for an attack in much the same manner that allies at war coordinate attacks. Additionally, two players may work together to define an overall strategy with a first player being a lower ranking officer to a second player. In this example, the first player would provide input for portions of military assets under their control and the higher ranking officer could alter or augment that strategy prior to providing an indication that a given strategy definition is complete. Of course, this concept could be extended to potentially many users on each side of a simulated conflict where a first set of users could coordinate their strategy when competing against a second set of users.

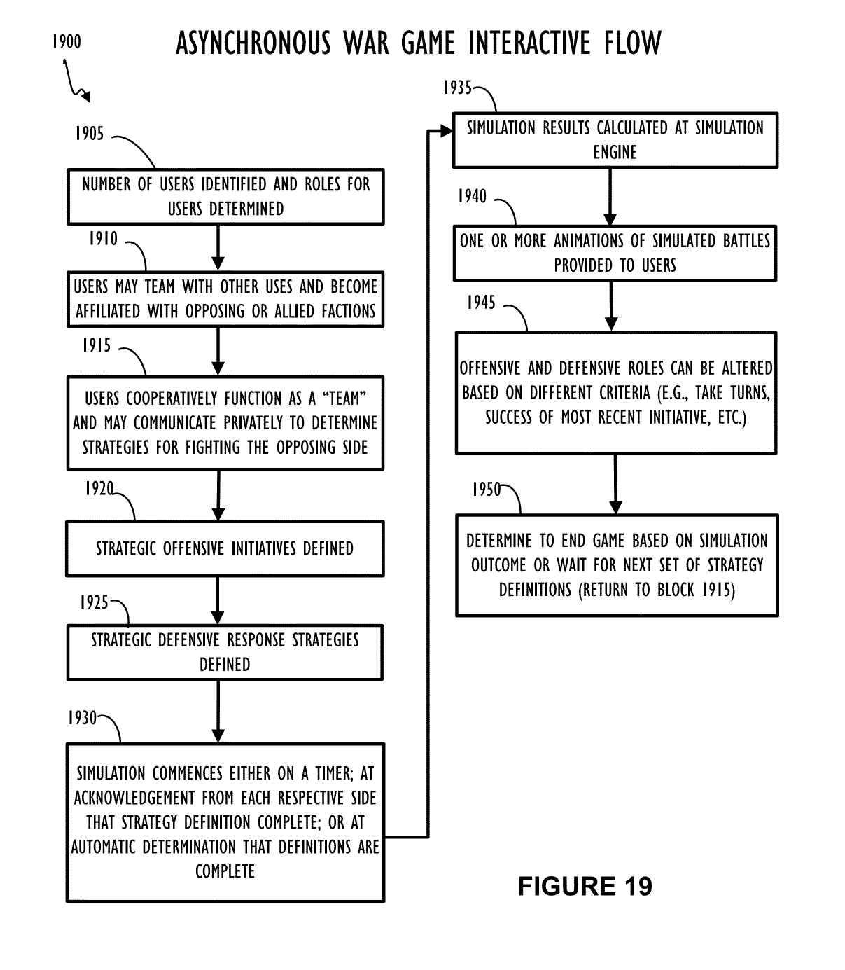

Referring now to FIG. 19, flow chart 1900 illustrates a possible process flow for an application game relating to a multi-player war game according to some disclosed embodiments. Beginning at block 1905 a number of users for an interactive competition of a war game progressive simulation, and the user's roles therein, may be determined. At block 1910, users may team with other users to form groups of affiliated users for at least two sides of a conflict. While this example illustrates a two-sided conflict, it is envisioned that a multi-sided (three or more sides) conflict is within the scope of this disclosure. Once users are affiliated, flow continues to block 1915 where groups of users may function as a team and may communicate privately with their other team members to determine a strategy for fighting the opposing side(s). At block 1920, strategic offensive initiatives are determined resulting in something similar to an offensive play definition as described above. Next, at block 1925, a strategic defensive response strategy may be defined. Both the strategic offensive initiatives and the strategic defensive response strategy are captured by the simulation engine. As with the above disclosed embodiments, a subset of information from the offensive definition may be provided to the users on “defense” so that they may more accurately provide a definition to result in a meaningful interaction of definitions (e.g., interaction at the simulation engine). Flow continues to block 1930 where the simulation engine begins simulation. Because of the number of players involved, there may be more than one way to initiate each iteration of progressive simulation. In a first example, the simulation may be run on a timer (e.g., once per hour, day, week) depending on preferences of the user group for this competition. In a second example, the simulation may be commenced after an indication from each respective side that strategy definitions are completed. In a third example, an automatic determination may be used to determine that enough of the definition is complete to commence simulation. The automatic determination may be made based on a combination of amount of time since the initiation of this micro game loop and amount of definition available (e.g., percentage of users from a side that have responded) or a different automatic determination criterion. Flow continues to block 1935 where simulation results are calculated in the simulation engine. After the simulation engine completes its calculation of the interaction of multiple strategy definitions, flow continues to block 1940, where one or more animations of one or more simulated battles may be provided to users. It is possible that two different battles at two different locations on the overall battlefield (e.g., world) may be calculated for a single iteration of the micro game loop. As in a real war, geographically distant battles will not have a direct result on each other but may limit available resources for the distinct battles. Block 1945 indicates that offensive and defensive roles may be alternated between the sides using different criteria. For example, the sides may take turns and alternate offensive attack definitions and responsive defensive strategies. Alternatively, a side may maintain its offensive position based on the success of its most recent initiative. Clearly, there are other possible ways to determine which side is on offense at any given time and a combination of different criteria may be used. At block 1950, it may be determined if one side has won the war because the military strength of another one of the sides has been depleted, or flow may return to block 1915 for a next progressive strategy definition and micro game loop iteration. As described herein, a user may ‘input’ a gesture into a device, e.g. a program control device, via a touch screen of the device, e.g., by running their finger over the touch screen thus defining a path on a virtual field of play (or field of battle, etc.) displayed on the touch screen. The device, or applicable components thereof, may translate the user's gesture into a path that may be displayed (e.g., by a line) on the virtual field on the screen. The device may calculate an interaction (of plays or strategies), perform a simulation, and create and display on the screen an animation of a player moving according to the path defined by the gesture. The device may create and display an overall or collective animation including animations or motions of multiple players. Such animation may visually represent motions or actions of multiple players based on play definitions/strategies created by users, interactions of multiple players based on interactions of play definitions/strategies created by different users, and outcomes (both intermediate and final) of those interactions. Such functionality may be achieved by hardware, software, firmware or any combination of any of these, including any of algorithms, logic, instructions, etc., such as has been described herein. Accordingly, a device such as described herein may perform a number of transformations transforming inputs (e.g., gestures, play/strategy definitions, etc. inputted by users; game variables, parameters, etc. which may be set by the device with or without user input; etc.) to create outcomes (e.g., final outcomes and multiple stages of intermediate outcomes) generated by a simulation engine, visual representations, on a display of a device (e.g., static graphic images and animated video), of those outcomes and of how those outcomes come about, and associated audio output from the device. Thus, the device creates physical, sense-perceptible results (e.g., visual images (moving and static) and audible content) by transforming inputs to the device.

In light of the principles and example embodiments described and illustrated herein, it will be recognized that the example embodiments may be modified in arrangement and detail without departing from such principles. Also, the foregoing discussion has focused on particular embodiments, but other configurations are also contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments may be combinable with one another, unless indicated otherwise.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, and processes in which the individual operations disclosed herein are combined, subdivided, rearranged, or otherwise altered.

This disclosure may include descriptions of various benefits and advantages that may be provided by various embodiments. One, some, all, or different benefits or advantages may be provided by different embodiments.

In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope of the following claims, and all equivalents to such implementations.

What is claimed is:

1. A computer system configured to assist in asynchronous gaming and progressive simulation, the computer system comprising:
a simulation engine;
a network interface; and
one or more processors communicatively coupled to the network interface and/or configured to execute the simulation engine,
wherein the one or more processors are further configured to:
receive, via the network interface, a first input regarding a first offensive strategy definition, the first input originating at a first device associated with an offensive user;
provide first information via the network interface to a second device associated with a defensive user, the first information pertaining to an offensive strategy formation associated with the first offensive strategy definition;
receive a second input regarding a first defensive strategy definition, the second input originating at the second device, wherein the second device need not be in active communication with the computer system when the first input is received, and the first device need not be in active communication with the computer system when the second input is received;
provide at least a portion of the first input and the second input to the simulation engine for processing a simulation of a first interaction of the first offensive strategy definition and the first defensive strategy definition by, at least in part, calculating an interaction using at least a portion of the first input and at least a portion of the second input;
obtain a result from the simulation engine; and
provide second information to the first device, the second information comprising information to facilitate rendering, on the first device, an animation indicative of the calculated interaction.

2. The computer system of claim 1, wherein the one or more processors are further configured to provide third information to the second device, the third information comprising information to facilitate rendering, on the second device, an animation indicative of the calculated interaction.

3. The computer system of claim 1, wherein the second information and the third information are the same based on a determination that the first device and second device are compatible with a common set of information to facilitate rendering.

4. The computer system of claim 1, wherein while the second device need not be in active communication with the computer system comprises the second device not being communicatively coupled to the computer system.

5. The computer system of claim 1, wherein the one or more processors are further configured to interface with a fantasy sporting site.

6. The computer system of claim 5, wherein the one or more processors are further configured to provide team definition information obtained from the fantasy sporting site.

7. The computer system of claim 5, wherein the one or more processors are further configured to utilize player statistical information obtained from the fantasy sporting site.

8. The computer system of claim 1, wherein the one or more processors are further configured to interface with a social media site.

9. The computer system of claim 8, wherein the one or more processors are further configured to utilize league definition information obtained from the social media site.

10. The computer system of claim 8, wherein the one or more processors are further configured to automatically post match information to the social media site.

11. The computer system of claim 1, wherein the first input regarding a first offensive strategy definition comprises information defined using touch screen gestures on the first device.

12. The computer system of claim 1, wherein the second input regarding a first defensive strategy definition comprises information defined using touch screen gestures on the second device.

13. The computer system of claim 1, wherein the information to facilitate rendering an animation comprises information to provide an audio call indicative of the calculated interaction on the first device concurrently with rendering the animation.

14. The computer system of claim 1, wherein the first offensive strategy definition comprises an offensive strategy definition for an athletic competition selected from the group consisting of: a baseball game, a soccer game, a hockey game, a football game, and a basketball game.

15. A method, comprising:
scheduling an interactive competition between a first set of users, each user of the first set of users associated with at least one of a first plurality of devices, and at least one second set of users, each user of the second set of users associated with at least one of a second plurality of devices, the interactive competition comprising an offensive strategy, a defensive strategy, and a number of iterations;
obtaining a first iteration of an offensive strategy definition provided by the first set of users;
providing access to at least a portion of the first iteration of the offensive strategy definition from the second plurality of devices;
presenting at least a portion of the first iteration of the offensive strategy definition as presented information to a display screen on at least one of the second plurality of devices;
obtaining a first iteration of a defensive strategy definition provided by at least a portion of the at least one second set of users, the first iteration of the defensive strategy definition responsive to the presented information;
providing the first iteration of the offensive strategy definition and the first iteration of the defensive strategy definition to a simulation engine;
obtaining an initial condition representing a current state of the interactive competition at the simulation engine;
calculating a result state using the simulation engine to apply a change to the initial condition, the change based at least in part upon the first offensive strategy and an interaction of the first offensive strategy with the first defensive strategy; and
providing information to present one or more intermediate states, calculated by the simulation engine, as an animation on at least one display screen of the first or second plurality of devices, the animation indicative of the calculated interaction.

16. The method of claim 15, wherein scheduling an interactive competition comprises selecting the first set of users and the at least one second set of users based, at least in part, on the first set of users and the at least one second set of users being members of a competition league.

17. The method of claim 15, wherein the scheduling of an interactive competition comprises selecting the first set of users and the at least one second set of users based, at least in part, on the first set of users having an experience rating within a pre-defined threshold of the at least one second set of users, and the at least one second set of users having an experience rating within a pre-defined threshold of the first set of users.

18. A device, the device comprising:
a touch screen;
a network interface;
a memory configured to store instructions and data; and
one or more processors communicatively coupled to the touch screen input, the network interface, and the memory,
wherein the one or more processors are configured to execute the instructions stored in the memory to cause the one or more processors to:
receive an indication of a selected strategy type as a result of a user interacting with the touch screen;
present a representation of the selected strategy type on the touch screen;
obtain information pertaining to adjustments of a strategy definition, the information associated with gestures performed by the user on the touch screen;
receive an indication that the user has completed making adjustments; and
transmit at least a portion of the strategy definition via the network interface from the device to a different device.

19. The device of claim 18, wherein the one or more processors are further configured to execute the instructions stored in the memory to cause the one or more processors to:
permit the user to perform a gesture on the touch screen, to define a path on the touch screen corresponding to the gesture performed by the user, to provide as part of a definition that a player associated with the gesture should attempt to follow the defined path on the touch screen in a video animation according to a simulation of a game.

20. The device of claim 18, wherein the one or more processors are further configured to execute the instructions stored in the memory to cause the one or more processors to:
receive, via the network interface, animation information indicative of intermediate and final results of a simulation based on an interaction of the strategy definition with at least one other strategy definition; and
present on the touch screen an animation derived from the interaction.
